(19) United States
(12) Patent Application Publication
(10) Pub. No.: US 2006/0045288 A1
(43) Pub. Date: Mar. 2, 2006

(54) Speaker talks II

(76) Inventor: Henry Adams III, Stafford, TX (US)

Correspondence Address: Henry Adams III;Apt C, 11515 Meadow Pines Ct, Stafford, TX, 77477, US

(21) Appl. No.: 11/042,370

(22) Filed: Mar. 17, 2005

Related U.S. Application Data
(60) Provisional application No. 60/603,747, filed on Aug. 24, 2004.

(51) Int. Cl. H04B 5/00; H04B 3/00

(52) U.S. Cl. 381/77; 381/79

(57) ABSTRACT

There are so many advantages to SPEAKER TALK II. One of the two main advantages is that, far and formost it will save lives in many oases of driving especially long distance driving.Road trips will not be the same again. Who will fall asleep singing along their favourite song while driving and actually hearing themselves at the same tone as the music playing?Another advantage to the SPEAKER TALK II is the purpose of entertainment. Can you imagine yourself driving back and forth, to and from work or wherever you may go,singing along to your favourite song or whatever kind of music you like to listen to at any particular time with your voice coming out the speakers with the music sounding as if you were actually part of the those responsible for singing those lyrics in the song while driving comfortably?Keeping drivers comfortable behind the wheel doing what one will enjoy,will create less road mishaps.

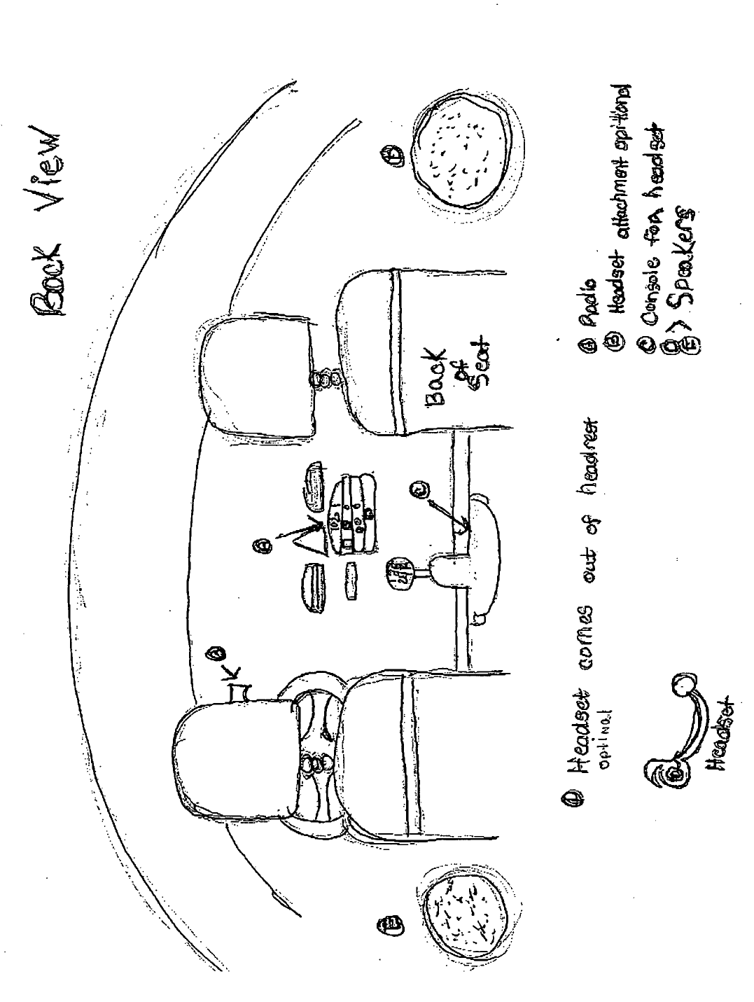

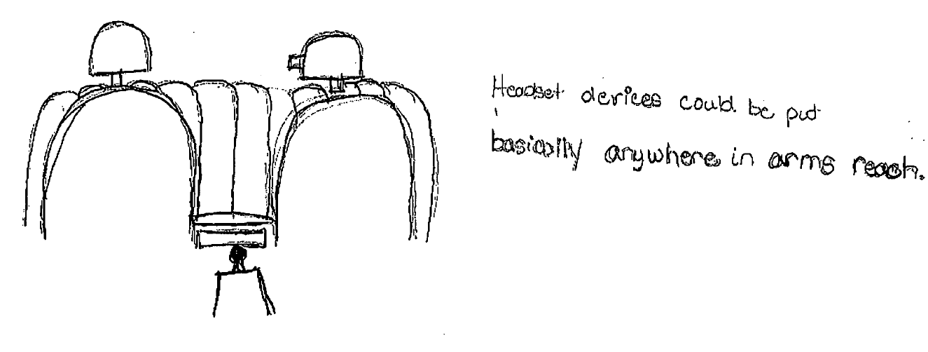

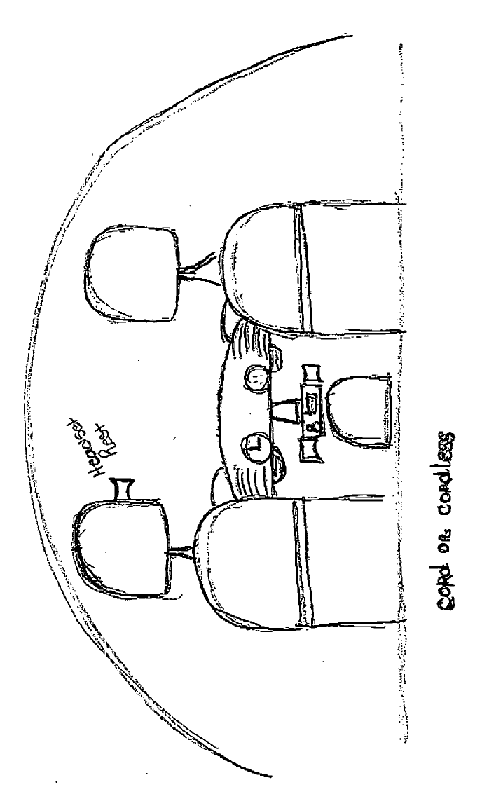

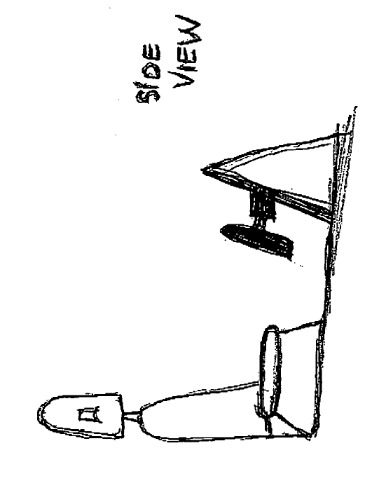

SPEAKER TALK II operates and works by generated frequencies through the headset and radio to allow ones voice or words to enter through the headset itself with your voice coming out the speakers, in your vehicle, by the push of a button or even voice activated.

The headset allows you possible ways of controlling the stereo,stop,pause and play.Putting the volume control within reach i.e. on the dashboard, elbow console or the steering wheel, may give one the abillity to change settings without affecting driving. The abillity of technology today with computer frequencies allows less of so much wiring.Volume control can be adjusted to override the music being played to make your voice sound much louder than the lyrics to a song you may be listening to or viceversa. The SPEAKER TALK II allows one to actually enjoy one's own voice combined with whatever song or music one is playing in the comfort of their own vehicle.

I claim:

1. SPEAKER TALK II. It consists of playing music, in your vehicle, while singing along with your voice transmitted through the radio by way of a Headset.
